(19) United States
(12) Patent Application Publication
(10) Pub. No.: US 2003/0174046 A1
(43) Pub. Date: Sep. 18, 2003

(54) System and method for maintaining, tracking and identifying the integrity of a disposable specimen container with a re-usable transponder

(76) Inventor: Robert S. Abrams, Albany, NY (US)

Correspondence Address: DREIER & BARITZ LLP, 499 PARK AVENUE, 20TH FLOOR, NEW YORK, NY, 10022, US

(21) Appl. No.: 10/363,210

(22) PCT Filed: Sep. 5, 2001
(86) PCT No.: PCT/US01/27609

(30) Foreign Application Priority Data
Sep. 5, 2000 (US) 60229917

(51) Int. Cl. H04Q 1/00

(52) U.S. Cl. 340/5.92

(57) ABSTRACT

A method of maintaining, tracking and identifying the integrity of a disposable specimen container comprising the steps of: writing to an RFID device attached to an individual specimen vial information including the date and a unique identification of the vial; putting sample in the specimen vial; writing to the RFID device attached to the specimen vial information including the time and the day; storing the vial in an environment to maintain its integrity; sending the vial to a laboratory for analysis; inventorying the vials by scanning the RFID attached to the individual vials; and separating the RFID device from the vial so that the RFID device may be re-used.

### BACKGROUND OF THE INVENTION

Radio frequency identification (RFID) tags and radio frequency identification tag systems are used for identification and/or tracking of equipment or inventory such as pallets, trucks, dollies or boxes or even the whereabouts of some animals, such as livestock in certain situations. These RFID systems are radio communication systems in which communications is provided between a radio transceiver, or interrogator, and a number of small, identifying labels or tags. These tags are read while in the radiation pattern or field of the interrogator, which may be connected to a computer-based tracking system. The intent of an RFID system is to provide a reliable and secure architecture that meets a predetermined performance requirement, while minimizing the cost of the interrogator and the tags.

Conventionally, in the operation of RFID systems, the interrogator transmits to the tags using modulated radio signals, and the tags respond by transmitting modulated radio signals back to the interrogator. Specifically, the interrogator first transmits an amplitude modulated signal to the tag. Next, the interrogator transmits a continuous-wave (CW) radio signal to the tag. The tag then modulates the CW signal using modulated back scattering (MBS) wherein the antenna is electrically switched, by the tag's modulating signal, from being an absorber of radio frequency (RF) radiation to being a reflector of RF radiation; thereby encoding the tag's information onto the CW radio signal. The interrogator demodulates the incoming modulated radio signal and decodes the tag's information message. A radio frequency identification tag system conveniently provides for reading the information from the radio frequency identification tag at a small distance using radio frequency (RF) data transmission technology. Typically, the user simply holds or places the radio frequency identification tag near a base station that transmits an excitation signal to the radio frequency identification tag powering circuitry contained on the radio frequency identification tag. The circuitry, responsive to the excitation signal, communicates the stored information from the radio frequency identification tag to the base station, which receives and decodes the information. In general, radio frequency identification tags are capable of retaining and, in operation, transmitting a substantial amount of information-sufficient information to uniquely identify individuals, packages, inventory and the like.

In one application that is relevant to the present invention, specimen containers (e.g. vials) are used conventionally in the dairy and the drug testing industries. In such industries, a unique specimen sample (e.g. milk in the dairy industry, and blood or urine in the, drug testing industry) is maintained in the vial. The unique specimen must be identified and tracked. In some applications, the specimens are identified and tracked by a unique bar code. Bar codes are typically located using a hand held optical scanner. Such bar code labeling systems utilize a light beam emitted from the scanner to “read” the bar code label. These systems require a direct line of sight between the scanner and the bar-code label, thus greatly limiting their utility.

In addition, the specimen containers may be provided with access that can be gained only by producing visible evidence that the container has been opened whether by accident or on purpose (e.g. use of tape or seal). Such a container is useful in the transportation and storage of liquid specimens for example, to ensure the integrity, of the specimen. The integrity of the specimen in the vial is becoming increasingly important in the dairy industry and for drug testing. It is important to ensure the so-called “guaranteed chain of custody” of the container contents by providing a “tamper-evident” seal to the vial—to protect from being opened by unauthorized personnel who might tamper with the contents.

### DETAILED DESCRIPTION OF THE PRESENT INVENTION

The present invention generally relates: (a) to a disposable specimen container that has a reusable RFID and that has the RFID secured to the vial in a tamper-evident mode; and (b) to a method of maintaining, tracking and identifying the integrity of a specimen container using a disposable specimen container and a reusable RFID

In one embodiment, the present invention employs an RFID device. Suitable RFID devices include a read-only or a read/write transponder. For a read/write RFID device, the transponder acts as a both a storage device and a display device. Examples of RFID devices suitable for the present invention include: (a) the “RI-TRP,” “RI-101,” “RI-102,” and “RI-103” models from Texas Instruments; and (b) the “GemWave Ario” and the “GemFly” models from Gemplus. The specific transponder may be chosen based on the specific application including: (a) the size and shape of the container and thus, the maximum surface area that is available for the transponder, (b) the environment (humidity, hazards and degree of special handling); (c) the need to re-use the transponder; (d) the memory capacity; (e) the size of the antenna; and (f) the cost. It is understood that the RFID device of the present invention includes any equivalent device that has the capability of both reading and writing such as the category referred to as “transponders.”

For the dairy industry, the following is one embodiment of the method of the present invention:

(a) information including the date and a unique identification of the vial is written to the RFID device attached to the individual specimen vial;

(b) the vials are sent to the dairy (and/or given to a tank driver);

(c) when the milk is pumped from a specific tank at the dairy to the tanker truck, a milk sample is taken (either automatically or manually) and is put in the specimen vial;

(d) information including the specific dairy, the specific dairy tank, the time, the day and/or the temperature of the milk are written to the RFID device attached to the specimen vial;

(e) the vial is then stored in an environment to maintain its integrity (e.g. insulated container, refrigerator unit);

(f) the vial(s) are sent to a laboratory for analysis;

(g) at the laboratory, the vials are inventoried by scanning the RFIDs attached to the individual vials;

(h) at the laboratory, information including the routing (e.g. test required such as fat/protein/bacteria/antibiotics analysis) of the sample is written to the RFID attached to the individual specimen vial; and

(i) the RFID device is separated from the vial so that the RFID device may be re-used and the corresponding vial is ground-up so that the plastic may be recycled.

In a more specific embodiment of the above-described method, a hand-held scanner may be used to either write information to and/or read information from the RFID device. For example, the tank driver and/or the dairy may use the hand-held scanner to read/write information including: (a) the date and a unique identification to the RFID device attached to the individual specimen vial; and (b) when the milk is pumped from a specific tank at the dairy to the tanker truck, the specific dairy, the specific dairy tank, and/or the temperature of the milk to the RFID device attached to the specimen vial. In another example, the laboratory personnel may use the hand-held scanner to read/write information including: (a) an inventory of the individual vials by reading the unique identification corresponding to the vial; and/or (b) routing information (e.g. test required such as fat/protein/bacteria/antibiotics analysis) of the sample by writing to the RFID device attached to the individual specimen vial. In another embodiment, the RFID device attached to the vial may be scanned without requiring a direct line of sight between the scanner and the RFID device. In this way, the vials contained within the larger containers do not need to be taken out and individually scanned.

For the drug testing industry, the following is one embodiment of the method of the present invention:

(a) information including the date and a unique identification of the vial is written to the RFID device attached to the individual specimen vial;

(b) the vials are sent to the office (e.g. physicians office, testing laboratory) where the patients urine or blood specimen is obtained;

(c) when the patient's blood or urine specimen is obtained, the specimen is put in the specimen vial;

(d) information including the individual's identification, the time, the day and/or additional office information are written to the RFID device attached to the specimen vial;

(e) the vial(s) are sent to a laboratory for analysis;

(f) at the laboratory, the vials are inventoried by scanning the RFIDs attached to the individual vials;

(g) at the laboratory, information including the routing (e.g. test required such as the type of drug to be tested for) of the sample is written to the RFID attached to the individual specimen vial; and

(h) after all testing is complete and the specimen is no longer needed, the RFID device is separated from the vial so that the RFID device may be re-used and the corresponding vial is ground-up so that the plastic may be recycled.

In yet a further embodiment of the present invention, the routing step may be automated so a conveyor-like system is designed where the vials are automatically routed to the proper station based on a scanner reading the individual RFID devices attached to each vial.

In a further embodiment of the RFID device, radio frequency identification tag is formed by directly joining a radio frequency identification tag circuit chip (“circuit chip”) to an article having an integrally formed antenna. Article may be a substrate formed from a sheet of material. The substrate may be the specimen container. Moreover, the substrate material may be any suitable material for the particular application such as paper, plastic (including polyester and metalized polyester material), synthetic paper, reinforced paper, cardboard, coated cardboard and the like.

In one embodiment, the RFID tag is attached to the container which identifies the container and thus the customer. For example, this tag may be secured to any part of the container including the lid, the bottom, the side or the top of the container. As such, the vial may be specifically designed to accommodate the RFID device. Such a tag may include a relatively flat or thin coil connected to an integrated circuit (IC) disposed within the confines of the coil. Thus, the coil of RFID tag is disposed substantially in a horizontal plane within the lid.

The apparatus and process of the present invention may be used with a variety of bodies including bottles, vials, spouts or any other containers. Although the examples describe a vial, the invention covers any type of container that may be used to transport specimen samples. The invention is described in the description with respect to a vial.

In another embodiment, the vial may be cylindrical in shape with an integrally formed bottom. A cap may be provided which is adapted to seal the vial closed with a substantially hermetic seal. The cap may be integrally connected to the vial with a small flange. The vial and cap may be injection molded in the mold from a thermoplastic material. Examples of processes of making such vial and of designs for such vials are disclosed in U.S. Pat. Nos. 4,812,116, 4,783,056 and 5,723,085 that are incorporated by reference herein.

In a further embodiment, vials of the type to which the present invention relates are generally injection-molded plastic vials that have caps adapted to seal the vial closed with a substantially hermetic seal. The cap may or may not be integrally connected to the vial, but is preferably joined thereto with a small flange. It is important to maintain the sterility of the interior of the vial prior to use. Accordingly, in order to maintain the sterility of the interior of the vial the cap must be closed onto the vial while the vial is in an aseptic environment.

In a further embodiment of the present invention, the vial is designed so that the RFID device is sufficiently secured to the vial so that the RFID device remains attached to the vial during regular shipping and handling. Such a securing device may include, but are not limited to, a clip-on system, a slotted system, and snap-on system. At the same time, the securing device is designed so that, after the specimen has been tested, the RFID device may be intentionally removed from the vial with out incurring damage to the RFID device. In this way, the RFID device may be re-used while the corresponding vial is ground-up and the plastic material may be recycled. The present invention takes advantage of the ability to dispose of the vial after each use so as to maintain integrity and sterility of the specimen sample while, at the same time, to re-use the RFID device. Consequently, the present invention is environmentally “green”—the vial may be recycled and the plastic reused and the RFID device may be continually re-used. In one embodiment, an automatic system may be designed where the RFID is automatically removed from a used vial and is inserted in a new vial while the used vial is ground-up and prepared for recycling. One process of automatically recycling the vial is disclosed in U.S. Pat. No. 5,979,804, which is incorporated by reference herein.

In another aspect of the present invention, the vial may be a tamper-proof container and cap for indicating whether the container has been opened during transport to or from a specimen-receiving site. For example, one or more destructible connections are provided between the container and cap, that connection including one or more destructible members which hold the cap in a closed condition whereby the cap can be opened only in response to the destruction of the destructible member. Accordingly, an opening of the closed container during transport thereof to a specimen-receiving site (e.g. a laboratory) is evident from a destruction of the destructible member. One embodiment of such a tamper-proof design is described in U.S. Pat. No. 5,012,941, which is incorporated by reference herein.

In yet another aspect of the present invention, the device that secures the RFID device to the vial may be a tamper-proof design for indicating whether the RFID device has been either replaced with another RFID device or has been tampered with during transport to or from a specimen-receiving site and/or during handling. For example, one or more destructible connections may be provided between the RFID device and container, that connection including one or more destructible members which hold the RFID device to the container whereby the RFID device can be removed from the container only in response to the destruction of the destructible member. Accordingly, tampering with the RFID device during transport and/or handling thereof to a specimen-receiving site (e.g. a laboratory) is evident from a destruction of the destructible member.

What is claimed:

1. A method of maintaining, tracking and identifying the integrity of a disposable specimen container comprising the steps of:
(a) writing to an RFID device attached to an individual specimen vial information including the date and a unique identification of the vial;
(b) putting sample in the specimen vial;
(c) writing to the RFID device attached to the specimen vial information including the time and the day;
(d) storing the vial in an environment to maintain its integrity;
(e) sending the vial to a laboratory for analysis;
(f) inventorying the vials by scanning the RFID attached to the individual vials; and
(g) separating the RFID device from the vial so that the RFID device may be reused.
